(19) United States
(12) Patent Application Publication
(10) Pub. No.: US 2006/0017850 A1
(43) Pub. Date: Jan. 26, 2006

(54) VIDEO COMBINING APPARATUS AND METHOD THEREOF

(76) Inventors: Ming-Jane Hsieh, Taipei City (TW); Zou-Ping Chen, Tai-Chung City (TW); Cheng-Shun Liao, Chang-Hua Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,077

(22) Filed: Jul. 22, 2005

(30) Foreign Application Priority Data
Jul. 23, 2004 (TW) 093122122

(51) Int. Cl. H04N 5/445

(52) U.S. Cl. 348/564; 348/584

(57) ABSTRACT

A video combining circuit includes: a video component controller for receiving and processing a first video component signal to output a first video signal including location information; and a video signal controller coupled to the video component controller for receiving the first video signal and a second video signal and choosing one of the first and second signals according to the location information to output a video composite signal; wherein the first and second video signal does not overlap.

### BACKGROUND OF THE INVENTION

1. Field of the Invention

The present invention relates to digital TV, and more particularly, to a video combining circuit for a digital TV and method thereof.

2. Description of the Prior Art

Compared with conventional CRT-type displays, flat panels such as LCD panels and PDP panels have the property of low thickness, thereby possessing considerable advantage for high-level TV application of large displaying size. As the technique involved in manufacturing LCD and PDP panels advances, TVs equipped with LCD or PDP panels have become more and more popular. Because these modern high-level TVs generally support a picture-in-picture (PIP) function, a user can view two TV programs on the same TV screen at the same time.

Obviously, however, a main-video signal and a sub-video signal respectively corresponding to two programs need to be decoded, as well as subtitle information of the main-video signal and subtitle information of the sub-video. For example, referring to FIG. 1, a conventional video combining circuit first reads a plurality of video component signals from a memory, the signals respectively corresponding to a main-picture 214, a sub-picture 224, and a background picture 234. The video combining circuit then processes these video component signals independently, and combines the above-processed signals to output a composite picture 200. Therefore, a trade-off between the cost and the efficiency of a conventional digital TV exists because the conventional digital TV consumes a large proportion of the system resource and bandwidth in order to display two TV programs on the same TV screen at the same time.

### SUMMARY OF THE INVENTION

It is therefore one of the objectives of the claimed invention to provide a video combining apparatus for a digital TV and method thereof, so as to save the bandwidth needed for accessing memory.

The claimed invention provides a video combining circuit according to a first embodiment. The video combining circuit includes a first video component controller for receiving and processing a first video component signal to output a first video signal that includes location information; and a video signal controller coupled to the video component controller for receiving the first video signal and a second video signal and choosing the first or second video signal according to the location information for outputting a video composite signal, wherein the first video signal and the second video signal do not overlap.

The claimed invention further provides a video combining circuit according to a second embodiment. The video combining circuit includes a first video component controller for receiving and processing a first video component signal to output a first video signal that includes a first location information; a second video component controller for receiving and processing a second video component signal to output a second video signal; and a video signal controller coupled to the first and second component controllers for receiving the first video signal and the second video signal, and outputting the first video signal in a first time interval and the second video signal in a second time interval according to the location information.

The claimed invention also provides a corresponding video combining method. The video combining method includes outputting a first video signal according to a first video component signal, the first video signal containing a location information; outputting a second video signal according to a second video component signal; and combining the first and second video signals according to the location information to output a video composite signal, wherein the first video signal is a first portion of the video composite signal, the second video signal is a second portion of the video composite signal, and the first and second portions of the video composite signal do not overlap.

An advantage of the claimed invention is that the disclosed apparatus and method will not increase the bandwidth requirement for accessing memory when performing video composition, and therefore capable of improving data processing efficiency of a digital TV.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional video combining method.

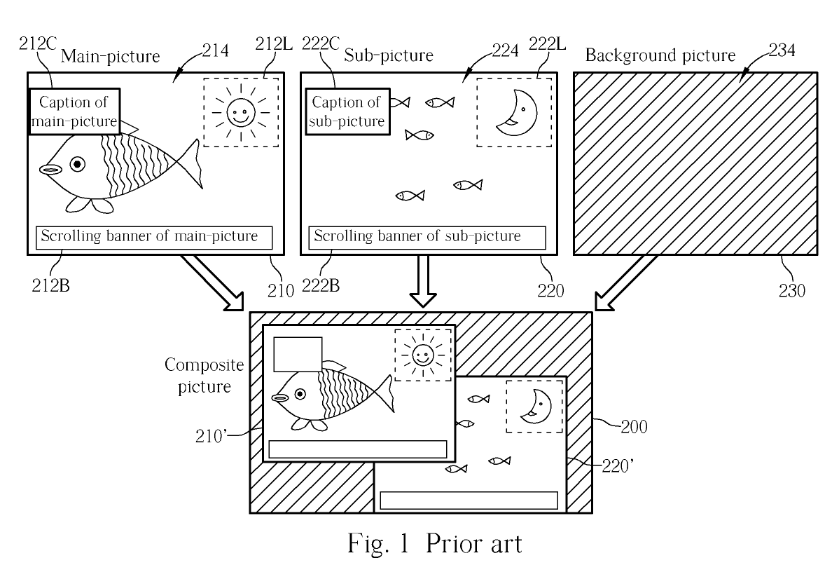

FIG. 2 is a diagram illustrating the system architecture of a digital TV according to the present invention.

FIG. 3 is a diagram of a processed composite picture of the digital TV shown in FIG. 2.

FIG. 4 is a diagram of a video combining circuit according to the present invention.

### DETAILED DESCRIPTION

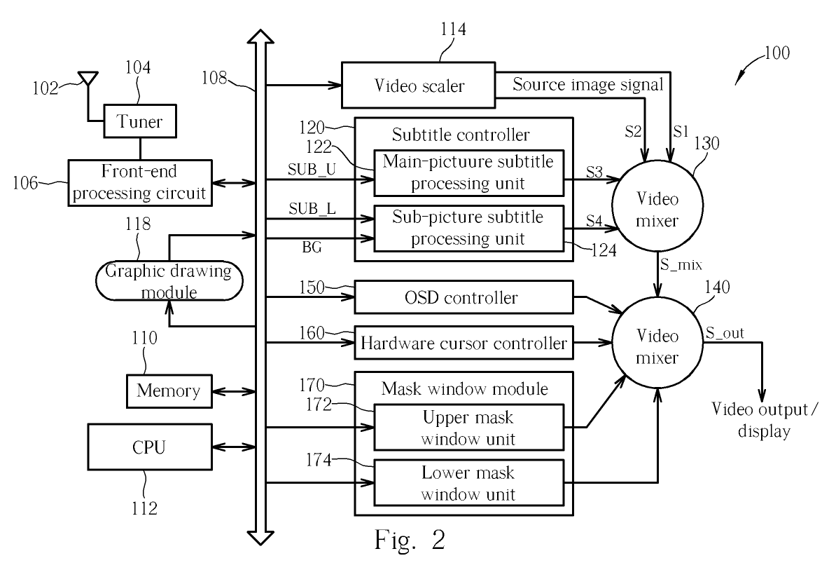

FIG. 2 is a diagram illustrating the system architecture of a digital TV 100 according to an embodiment of the present invention. As shown in FIG. 2, the digital TV 100 comprises an antenna 102, a tuner 104, a front-end processing circuit 106, a bus 108, a memory 110, a CPU 112, a scaler 114, a graphic drawing engine (GDE) 118, a subtitle controller 120, a plurality of video mixers 130 and 140, an on-screen display (OSD) controller 150, a hardware cursor controller 160, and a mask window module 170. The front-end processing circuit 106, after performing front-end processing on the digital TV signal received from the antenna 102 and the tuner 104, stores the processed data in the memory 110 through the bus 108. The CPU 112 can control other devices connected to the bus 108. The mask window module 170 performs video processing, such as edge enhancing, color changing, etc., upon the pixels within a selected mask window. The video scaler 114 reads an image data 214 of a main-picture 210 and an image data 224 of a sub-picture 220 from the memory 110 and generates a main-video signal S1 and a sub-video signal S2 by performing scaling on the image size of the read image data. After processing by the video mixers 130 and 140, the video signals S1 and S2 and other information are mixed together to generate a mixed signal S_mix and an output signal S_out corresponding to a composite picture 200, successively. The output signal S_out is further transmitted to a monitor, a video output port, or a video output terminal of the digital TV 100. Users can view the composite picture 200 on the monitor of the digital TV 100, or on a monitor of an external display unit coupled to the video output port or the video output terminal of the digital TV 100.

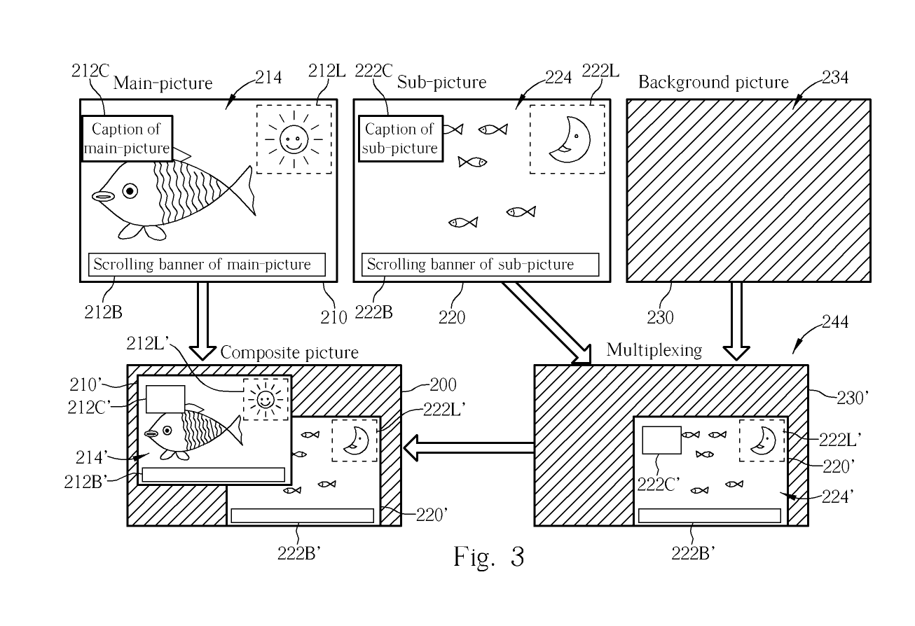

Please refer to FIG. 3. The picture 244 can be divided into at least two parts, a first video signal (i.e., the sub-picture 224) and a second video signal (i.e., the background picture 234). The video combining circuit according to the embodiment of the present invention is used for processing the first video signal and the second video signal. Since these two video signals do not overlap, the disclosed video combining circuit will not increase the bandwidth requirement for accessing the memory.

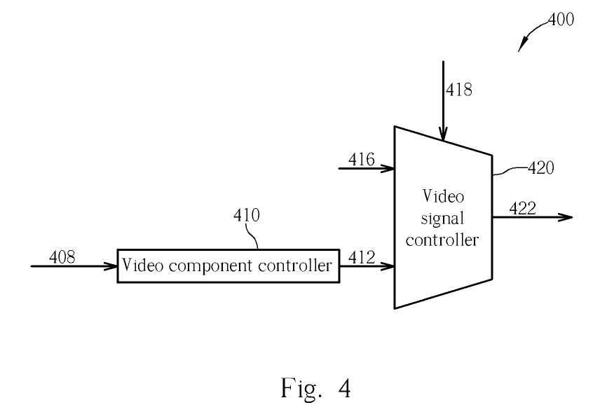

FIG. 4 is a diagram illustrating a video combining circuit 400 according to an embodiment of the present invention. The video combining circuit 400 includes a first video component controller 410 and a video signal controller 420. The first video component controller 410 can read an image data 408 (data of an image 222C, 222L, 222B, or 224 shown in FIG. 3) of a sub-picture 220 and output an image data 412 (data of an image 222C′, 222L′, 222B′, or 224) of a sub-picture 220′ after specific processing, such as video scaling. The video signal controller 420 receives an image data 412 of the sub-picture 220′ and a background information 416 corresponding to the background picture 230′, combines the image data of the sub-picture 220′ and the background information 416 according to a relative location information 418 of the sub-picture 220′, and generates an output data 422 corresponding to a combined frame 244. The video signal controller 420 can be a multiplexer since the image data of the sub-picture 220′ and the background information of the background picture 230′ in the output data 422 corresponding to the combined frame 244 do not overlap. Please note that the relative location information 418 can be expressed by a start coordinate and an end coordinate, or a start coordinate and a window size. In this embodiment, the first video component controller 410 is a controller for processing a windowed video signal. For example, the first video component controller 410 could be implemented by the video scaler 114, the subtitle controller 120 or the mask window module 170. The above-mentioned windowed video signal represents a video signal capable of being displayed by a window. Additionally, the above-mentioned relative location information 418 can be extended in its definition to be information 418 of a reserved region used for determining the display region reserved for the image data of the sub-picture 220′. When the size of the reserved region is set to zero, the output data 422 of the video signal controller 420 contains no image data of the sub-picture 220′. Please note that although the video signal controller 420 includes an input port for receiving the relative location information 418, this should not be taken as a limitation of the present invention. The video signal controller 420 can acquire the relative location information 418 in many different ways. For example, the header of the image data 408 of the sub-picture 220, read by the first video component controller 410 from the memory 110, contains the relative location information 418. Therefore, the video signal controller 420 can acquire the relative location information 418 from the first video component controller 410. In an embodiment of the present invention, the video signal controller 420 includes a location information identifier for acquiring the relative location information from the image data 408, and a multiplexer coupled to the location information identifier for combining the image data of the sub-picture 220′ and the background information 416 according to the relative location information and for outputting the output data 422 corresponding to the combined frame 244.

The subtitle controller 120 detailed below is taken as an example and is not meant to be a limitation of the present invention. The subtitle controller 120 is used for processing the image signals SUB_U and SUB_L of the subtitle data in the picture 210 and picture 220, such as image data of the caption 212C and 222C, image data of TV station Logo 212L and 222L, and image data of scrolling banner 212B and 222B. Then, the subtitle controller 120 outputs the corresponding video signals S3 and video signal S4 to the video mixer 130 for video signal mixing. The subtitle controller 120 is further fed with a background information signal BG of a background picture 230. In this embodiment, the subtitle controller 120 includes a main-picture subtitle processing unit 122 and a sub-picture subtitle processing unit 124, which respectively output a video signal S3 corresponding to the image signal SUB_U of the main-picture subtitle information and a video signal S4 corresponding to the image signal SUB_L of the sub-picture subtitle information and the background information signal BG. Out of these two video signals, the video signal S3 comprises image data only when a scanned location corresponds to the caption 212C, TV station Logo 212L or scrolling banner 212B of the main-picture 210. The video signal S4 comprises image data only when a scanned location corresponds to the slashed area of the background picture 230 of the composite picture 200, and the TV station Logo 222L or the scrolling banner 222B of the sub-picture 220. The video mixer 130, after receiving and mixing the signals S1, S2, S3 and S4, outputs the mixed signal S_mix of the composite picture 200.

According to the present embodiment, the CPU 112 is a control unit of the digital TV 100. In other words, the digital TV 100 is under the control of the CPU 112. The operation of the subtitle controller 120 is driven according to the control signal generated by the CPU 112, wherein the CPU 112 determines the control signal according to the properties of the pictures 210, 220 and a user command from a user interface (not shown) of the digital TV 100. For example, the control signal includes an enabling bit for a background picture. The subtitle controller 120 decides whether or not to display the background picture 230 according to the binary value of the enabling bit. If the subtitle controller 120 decides not to display the background picture 230, the subtitle controller 120 displays the slashed area of the composite picture 200 according to a background parameter in the control signal. According to the present embodiment, the background parameter is a background color parameter.

Based on the above-mentioned preferred embodiment, the present invention has another embodiment similar to the preferred embodiment. The major difference between these two embodiments is detailed as follows. In this embodiment, a firmware takes the place of the CPU 112 implemented in the above-mentioned preferred embodiment.

Please note that the same concept of the present invention can not only be applied to a main picture with a sub-picture in a PIP context, but can also be applied to the background with a picture of any size less than the whole screen.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video combining circuit comprising:
a video component controller for receiving and processing a first video component signal to output a first video signal including location information; and
a video signal controller coupled to the video component controller for receiving the first video signal and a second video signal and choosing the first or second video signal according to the location information to output a video composite signal;
wherein the first and second video signals do not overlap.

2. The video combining circuit of claim 1, wherein the video signal controller comprises a multiplexer.

3. The video combining circuit of claim 1, wherein the second video signal is a background signal.

4. The video combining circuit of claim 3, wherein the video component controller is a subtitle controller.

5. The video combining circuit of claim 1, wherein the location information comprises a start coordinate and an end coordinate.

6. The video combining circuit of claim 1, wherein the location information comprises a start coordinate and a window size.

7. A video combining circuit comprising:
a first video component controller for receiving and processing a first video component signal to output a first video signal including location information;
a second video component controller for receiving and processing a second video component signal to output a second video signal; and
a video signal controller coupled to the first and second video component controllers for receiving the first and second video signals, and outputting the first video signal in a first time interval and the second video signal in a second time interval according to the location information.

8. The video combining circuit of claim 7, wherein the video signal controller comprises a multiplexer.

9. The video combining circuit of claim 7, wherein the first and second time intervals do not overlap.

10. The video combining circuit of claim 7, wherein the second video signal is a background signal.

11. The video combining circuit of claim 10, wherein the first video component controller is a subtitle controller.

12. The video combining circuit of claim 7, wherein the location information comprises a start coordinate and an end coordinate.

13. The video combining circuit of claim 7, wherein the location information comprises a start coordinate and a window size.

14. A video combining method comprising:
outputting a first video signal according to a first video component signal, the first video signal including location information;
outputting a second video signal according to a second video component signal; and
combining the first and second video signals according to the location information to output a video composite signal;
wherein the first video signal is a first portion of the video composite signal, the second video signal is a second portion of the video composite signal, and the first and second portions of the video composite signal do not overlap.

15. The video combining method of claim 14, wherein the location information comprises a start coordinate and an end coordinate.

16. The video combining method of claim 14, wherein the location information comprises a start coordinate and a window size.
